(19) United States
(12) Patent Application Publication
(10) Pub. No.: US 2025/0193864 A1
(43) Pub. Date: Jun. 12, 2025

(54) INTELLIGENT BAND SWITCHING

(71) Applicant: DISH Wireless L.L.C., Littleton, CO (US)

(72) Inventor: In-Kyung Kim, Highlands Ranch, CO (US)

(21) Appl. No.: 19/062,728

(22) Filed: Feb. 25, 2025

Related U.S. Application Data
(63) Continuation-in-part of application No. 18/173,292, filed on Feb. 23, 2023.

(51) Int. Cl. H04W 72/0453; H04W 8/22; H04W 72/51; H04W 72/54

(52) U.S. Cl. CPC H04W 72/0453; H04W 72/51; H04W 72/54; H04W 8/22

(57) ABSTRACT

Various arrangements are presented for performing cellular communication using a frequency band for which a piece of user equipment (UE) is not optimized. The cellular network can be transmitted messages from the UE that indicate the unoptimized frequency band and an associated signal loss value for the band. The cellular network can then determine whether to use the unoptimized frequency band for communication based on measured signal strength and the reported signal loss value. Upon deciding to use the frequency band, the network can assign it for use to the UE via a message and proceed to communicate with the UE using that frequency band.

### CROSS-REFERENCES TO RELATED APPLICATIONS

This application is a continuation-in-part of U.S. Non-Provisional patent application Ser. No. 18/173,292, filed on Feb. 23, 2023, which is hereby incorporated by reference for all purposes.

### BACKGROUND

Telecommunications networks for existing carriers support various bands, and modern smart phones can use and aggregate multiple bands simultaneously. The smart phone tunes multiple bands (e.g., two or three bands), filters them, and performs baseband signal processing. As used herein, “LO” bands or “low bands” are those with frequencies of less than one gigahertz (GHz), and “HI” bands or “high bands” are those with frequencies of approximately 1.7 GHz or more. Table 1 below lists examples of supported fifth generation (5G) bands for AT&T®, Verizon®, T-Mobile®, and Sprint®.

TABLE 1
5G BANDS SUPPORTED BY CARRIERS

| Carrier: | Supported 5G Bands: |
|---|---|
| DISH ® | n26, n29, n48, n66, n70, n71, n77 |
| AT&T ® | n5, n77, n260 |
| Verizon ® | n2, n5, n66, n77, n260, n261 |
| T-Mobile ® | n41, n71, n260, n261 |

However, current smart phone form factors do not adequately facilitate the use of multiple low bands simultaneously. Accordingly, an improved and/or alternative approach may be beneficial.

### SUMMARY

In some embodiments, systems are provided. A system for cellular communication can include a user equipment (UE). The UE may be configured to communicate via a plurality of frequency bands with a cellular network. The hardware of the UE may not be optimized to communicate using multiple low frequency bands of the plurality of frequency bands together as part of a carrier aggregation (CA). The system can also include a cellular network comprising a base station that may be configured to communicate wirelessly with the UE via the plurality of frequency bands. The cellular network may be configured to receive, from the UE, one or more messages that can indicate a pair of low frequency bands and an unoptimized signal loss value corresponding to the use of the frequency bands. The cellular network can determine whether to use the pair of low frequency bands for communication with the UE based at least in part on a measured signal strength and the unoptimized signal loss value. Upon determining to use the pair of low frequency bands, the cellular network may transmit a message to the UE that can assign the pair of low frequency bands as part of the CA for communication with the base station. The cellular network may then communicate with the UE using the pair of low frequency bands.

Embodiments of such a system can incorporate one or more of the following features. That is, each of these features can be individually incorporated or incorporated in any combination with other features listed herein. The base station of the system may be configured to transition to a lower order form of modulation. The transition can occur in response to determining to use the pair of low frequency bands for communication. The hardware of the UE may cause a signal strength loss of at least 2 dB. The signal strength loss can occur when the pair of low frequency bands are used as part of the carrier aggregation (CA). Each low frequency band used for communication may be below 900 MHz. The unoptimized signal loss value may be at least 3 dB. The one or more messages received from the UE can comprise a device capability message. A gNodeB of the cellular network may be configured to determine whether to use the pair of low frequency bands for communication with the UE. The determination can be based at least in part on the measured signal strength and the unoptimized signal loss value.

In some embodiments, a method is provided. A method for using multiple low frequency bands for cellular communication can include receiving, by a cellular network from a user equipment (UE), one or more messages. The one or more messages may indicate a pair of low frequency bands and an unoptimized signal loss value corresponding to the use of the pair of low frequency bands as part of a carrier aggregation (CA). The UE can be configured to communicate via a plurality of frequency bands with a cellular network. The hardware of the UE may not be optimized to communicate using the pair of low frequency bands together as part of the CA. The cellular network can determine whether to use the pair of low frequency bands for communication with the UE based at least in part on a measured signal strength and the unoptimized signal loss value. Upon determining to use the pair of low frequency bands for communication with the UE, the cellular network may transmit a message to the UE. The message can assign the pair of low frequency bands for communication with a base station of the cellular network. The cellular network may then communicate with the UE using the pair of low frequency bands.

Embodiments of such a method can incorporate one or more of the following features. That is, each of these features can be individually incorporated or incorporated in any combination with other features listed herein. The determination to use the pair of low frequency bands for communication with the UE can be performed by a central unit (CU). The determination may be based at least in part on the measured signal strength and the unoptimized signal loss value. The cellular network may transition to a lower order form of modulation for communication with the UE. The transition can occur in response to determining to use the pair of low frequency bands for communication. The hardware of the UE may cause a signal strength loss of at least 2 dB. The signal strength loss can occur when the pair of low frequency bands are used as part of the carrier aggregation (CA). The loss may be compared to another frequency band of the plurality of frequency bands. Each of the low frequency bands used for communication may be below 900 MHz. The unoptimized signal loss value may be at least 3 dB. The one or more messages received from the UE can comprise a device capability message.

In some embodiments, a non-transitory processor-readable medium is provided. A non-transitory processor-readable medium for using an unoptimized frequency band for cellular communication can include processor-readable instructions. The processor-readable instructions may be configured to cause one or more processors to receive, from a user equipment (UE), one or more messages. The one or more messages may indicate a pair of low frequency bands which the hardware of the UE may not be optimized to use for communication as part of a carrier aggregation (CA). The one or more messages can also indicate an unoptimized signal loss value corresponding to the use of the pair of low frequency bands. The UE can be configured to communicate via a plurality of frequency bands with a cellular network. The hardware of the UE may not be optimized to communicate using the pair of low frequency bands together as part of the CA. The processor-readable instructions can further cause the processors to determine whether to use the pair of low frequency bands for communication with the UE. The determination may be based at least in part on a measured signal strength and the unoptimized signal loss value. Upon determining to use the pair of low frequency bands for communication with the UE as part of the CA, the processor-readable instructions may cause the cellular network to transmit a message to the UE. The message can assign the pair of low frequency bands for communication with a base station of the cellular network. The processor-readable instructions may further cause the cellular network to communicate with the UE using the pair of low frequency bands.

Embodiments of such a non-transitory processor-readable medium can incorporate one or more of the following features. That is, each of these features can be individually incorporated or incorporated in any combination with other features listed herein. The processor-readable instructions may be configured to cause one or more processors to determine whether to use the pair of low frequency bands for communication with the UE. The determination can be based at least in part on the measured signal strength and the unoptimized signal loss value. The instructions may be executed at a central unit (CU) of the cellular network. The processor-readable instructions may be further configured to cause the cellular network to transition to a lower order form of modulation for communication with the UE. The transition can occur in response to determining to use the pair of low frequency bands for communication as part of the carrier aggregation (CA). The one or more messages received from the UE may comprise a device capability message. The hardware of the UE may cause a signal strength loss of at least 2 dB. The signal strength loss can occur when the pair of low frequency bands are used as part of the carrier aggregation (CA). The loss may be compared to another frequency band of the plurality of frequency bands. Each of the low frequency bands used for communication may be below 900 MHz. The unoptimized signal loss value can be at least 3 dB.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not, therefore, to be considered to be limiting its scope, the invention will be described and explained with additional specificity and detail through the use of the accompanying drawings, in which:

FIG. 1 is an architectural diagram illustrating a carrier network and UE configured to implement intelligent band switching, according to an embodiment of the present invention.

FIG. 2 illustrates a smart phone with multiple antennas, according to an embodiment of the invention.

FIG. 3A is a flow diagram illustrating a process for releasing at least one LO band, according to an embodiment of the present invention.

FIG. 3B is a flow diagram illustrating another process for aggregating at least one additional LO band, according to an embodiment of the present invention.

FIG. 4 is a flowchart illustrating a process for performing intelligent band switching, according to an embodiment of the present invention.

FIG. 5 is an architectural diagram illustrating a computing system configured to

perform intelligent band switching and/or aspects thereof, according to an embodiment of the present invention.

FIG. 6 illustrates an embodiment of a method of for making a determination of whether to use a frequency band for which the UE is not optimized.

FIG. 7 illustrates another embodiment of a method of for making a determination of whether to use a frequency band for which the UE is not optimized.

### DETAILED DESCRIPTION

The hardware in most cellular devices, such as smartphones, cellular modems, tablet computers, gaming devices, smartwatches, etc., (collectively referred to as user equipment or UE) are optimized to make use of particular communication bands. A hardware manufacturer, such as a smartphone manufacturer, may make a design decision to include hardware that is approximately optimized for particular frequency bands, which may overlap. As the frequencies used for communication vary, the optimal hardware to utilize such frequencies changes. For example, the dimensions of an antenna can significantly affect the antenna gain.

Even when a UE is optimized for use with particular frequency bands, the UE is not prohibited from using other frequency bands. Rather, the use of such other frequency bands can be useful. For example, using hardware to transmit and receive on multiple LO frequency bands across a carrier aggregation could result in a significant amount of signal loss compared to if a single LO band or one or more HI bands are used. As an example, a 3 dB loss could occur for both transmitting and receiving signals using multiple LO frequency bands.

Nevertheless, in some circumstances, a significant amount of loss may be acceptable. For example, if a UE is close to a base station with high signal strength, even when significant signal strength loss is factored in, enough signal strength may be present for communication if the proper modulation scheme is used. By having this UE to simultaneously (i.e., both active at the same time for communication) use multiple LO frequency band, communication traffic on one or more other frequency bands (e.g., HI frequency bands) is decreased, thus increasing capacity for other UE using such frequency bands.

In order to make use of multiple LO frequency bands as part of a carrier aggregation, the UE, base station (e.g., gNodeB) or both need to be aware of the signal strength drop that will occur if the LO frequency bands are concurrently active and used for communication (uplink, downlink, or both) between the UE and the radio unit (RU) of the base station. In some embodiments, via either a modified device capability message or a separate message, the UE can inform the base station (e.g., gNB) about an expected amount of signal strength loss that will occur if particular LO frequency bands are actively being used for communication. The BS can then factor in this signal loss when selecting the LO frequency bands and modulation to be used by the UE in communicating. Alternatively, the UE can measure the signal strength and only “reveal” to the BS, such as via a device capability message, that the UE has the ability to use the LO frequency bands when the signal strength is sufficient that the anticipated signal strength drop would still allow for effective communication between the UE and BS with the LO frequency bands active as part of the carrier aggregation.

Some embodiments pertain to intelligent band switching. Multiple bands can be aggregated simultaneously, which is referred to as “carrier aggregation (CA).” CA provides more bandwidth and higher data rates. In order to aggregate two or more LO bands simultaneously (referred to herein as “LOLO”) and maintain adequate link performance, the antenna volume may need to be doubled and isolation increased. The effective antenna volume is the actual volume occupied by the radiating part of the antenna plus one-half wavelength airspace or other dielectric around the antenna. It may also be possible to aggregate the LO bands without changing the user equipment (UE) form factor by sacrificing signal strength. When the signal strength of the UE (e.g., a smart phone, a laptop computer or other computer with cellular communication hardware, etc.) is sufficiently high to maintain the link, LOLO may be used. In some embodiments, at least one HI band is used as well within the context of LOLO, but in LOHI mode, a single LO band is used. In certain embodiments, one or more of the HI bands that the UE was previously using in LOHI mode are released when switching to LOLO mode.

However, when the signal strength falls below a threshold minimum signal strength for using LOLO, the smart phone or other computing system switches to using a LO band and a HI band (referred to herein as “LOHI”). Such embodiments allow the use of more of the spectrum without practical limitations. In certain embodiments where no HI band(s) are available, the UE device may use a single LO band instead.

Carriers can have multiple LO bands, and LOLO CA may be beneficial. However, smartphones may not support LOLO due to the form factor limitations discussed above. Hence, combinations such as n71+n29, n26+n66+n71, etc. may not be supported. This is a significant limitation for the offered throughput and flexible use of frequencies that is alleviated by some embodiments.

The signal strength that is sufficiently high for using LOLO depends on the deployment. The radio access network (RAN) (e.g., a base station or gNodeB (gNB)) configures various thresholds for handover. The UE monitors the signal qualities for the frequency being used and the other frequencies, as well as the frequencies of neighboring cells. Based on the measurement and the thresholds, the UE is able to determine whether the coverage area is adequate for LOLO. Also, the UE can determine that if it loses 3 dB of signal power, for example, the UE would not lose the link or be forced to handover. In other words, a sufficiently high signal strength may be defined as one that enables the UE to maintain the link and not be forced to hand over. The UE can apply LOLO CA until the UE sees that it is being forced to hand over or lose the link. The UE can then cease using LOLO to gain a link margin (e.g., 3 dB).

When in LOLO mode, the UE knows when it nears the cell boundary through the measurements and the threshold values. Typically, in this situation, the base station or gNB will instruct UE for the measurement process, which is part of the preparation for handover. However, in some embodiments, the UE knows that handover is premature since if the UE releases LOLO, the UE will gain a certain link margin (e.g., 1.8 dB, 3 dB, etc.), for example, and stay on at least one of the LO frequencies. In other words, the UE releases one LO frequency from LOLO CA and stays on a single LO frequency or the original number of LOLO CA frequencies minus one and possibly additionally uses a HI frequency band.

At this point, the base station or gNB should know that the release of one of the LOLO frequencies, and the attendant dB increase, is not because of coverage loss of the released LO frequency. In other words, for UE not supporting LOLO (or a single LO frequency), the UE is still in the coverage area and sees a higher signal strength (link margin). Otherwise, the UE could confuse the base station or gNB of the LO band's proper coverage area. The UE can update its capability by removing LOLO for this purpose or indicate to the base station or gNB that the UE cannot accommodate the LOLO CA operation.

The opposite scenario is similar. When in a single LO band operation or LOLO operation where aggregation of an additional LO band may be possible, by its signal measurements, the UE will know that even if the attendant amount of power is lost, the UE can still maintain the link. The UE can then add the additional LO band for LOLO CA. The base station or gNB will start exercising LOLO with the UE accordingly.

5G operating frequency bands n26, n29, and n71 are LO bands, for example. Band n26, often referred to as “extended cellular (CLR),” is a full division duplexing (FDD) band (duplex spacing of 45 megahertz (MHz)) with a frequency of approximately 850 MHz (uplink 814-849 MHz and downlink 859-894 MHz) with channel bandwidths of 5, 10, 15, 20, 25, and 30 MHz. Band n29, often referred to as “lower SMH,” where SMH stands for seven hundred megahertz, is an FDD supplemental downlink (SDL) band with a frequency of approximately 700 MHz (downlink 717-728 MHz) with channel bandwidths of 5, and 10 MHz. Band n71, often referred to as “digital dividend,” is an FDD band (duplex spacing of-46 MHz) with a frequency of approximately 600 MHZ (uplink 663-698 MHz and downlink 617-652 MHZ) with channel bandwidths of 5, 10, 15, 20, 25, 30, and 35 MHZ.

5G operating frequency bands n48, n66, n70, and n77 are HI bands, for example. Band n48, often referred to as “citizens broadband radio service (CBRS),” is an FDD band with a frequency of approximately 3.500 GHz (uplink and downlink 3.550-3.700 GHz) with channel bandwidths of 5, 10, 15, 20, 30, 40, 50, 60, 70, 80, 90, and 100 MHz. Band n66, often referred to as “extended advanced wireless service (AWS),” is an FDD band with a frequency of approximately 1.700 and 2.100 GHz (uplink 1.710-1.780 GHz and downlink 2.110-2.200 GHz) with duplex spacing of approximately 400 MHz and channel bandwidths of 5, 10, 15, 20, 25, 30, 35, 40, and 45 MHz. Band n70, often referred to as “supplementary AWS,” is an FDD band with a frequency of approximately 1.700 and 2.000 GHz (uplink 1.695-1.710 GHz and downlink 1.995-2.020 GHz) with duplex spacing of approximately 300 MHz and channel bandwidths of 5, 10, 15, 20, and 25 MHz. Band n77, often referred to as “C-band,” is a time division duplexing (TDD) band with a frequency of approximately 3.700 GHz (uplink and downlink 3.300-4.200 GHz) with channel bandwidths of 10, 15, 20, 25, 30, 40, 50, 60, 70, 80, 90, and 100 MHz.

The UE may be configured to use LOLO as a default when there is sufficient signal strength to do so. In order to determine whether to use LOLO or LOHI, the UE measures the signal strength received at the device. When the device is using LOLO and the signal strength falls below a minimum signal strength threshold, or when the device is using LO or LOHI and the signal strength rises above the minimum signal strength threshold, the UE sends a communication to the carrier network indicating that aggregation of at least one additional LO band should occur, and potentially provides its capabilities (e.g., the UE model, the bands supported by the UE, the bands that the UE is currently using, the detected signal strength, etc.). The carrier network then reconfigures the UE to operate in LOLO or LO/LOHI, and the UE implements the change on its end via its low band antenna switches. Because the carrier network knows that the UE can operate in LOLO mode, the carrier network can enable LOLO CA. This may be performed by the RAN, for example, in order to reduce the load on carrier network equipment. However, in certain embodiments, the carrier network may assist in this switching decision (e.g., deciding regarding which band(s) to aggregate and/or which band(s) to release).

In some embodiments, more than two low bands may be used. For instance, if in a strong signal area and a certain reduction in signal strength can occur and still remain above the threshold (e.g., 4.8 dB), three LO bands could be utilized simultaneously. Even more bands may be used without deviating from the scope of the invention if the attendant drop in signal strength can be tolerated. Assuming that the antenna volume is fixed, and that the antenna gain for a single frequency is zero, the theoretical value for transmitting in multiple frequencies is 10*log(n), where n is the number of frequencies. This value can be used to provide the loss that will occur, which can be compared against the current signal strength to determine whether the UE can tolerate the loss. It should be noted that additional implementation loss should be added in practice, typically in fractional dB.

Consider the example where a carrier network uses LOLO and LOHI. In this case, two thresholds may be used to determine whether two band LOLO CA or three band LOLO CA is feasible. If a first signal strength drop can be tolerated while maintaining the link and minimum quality (e.g., a 4.8 dB signal strength drop), three band LOLO CA may be used. If this is not the case, but a certain lower signal strength drop can still be tolerated (e.g., a 3 dB signal strength drop), two band LOLO CA may be used. If neither can be tolerated, LO or LOHI may be used. Any number of LO bands for CA may be used in this manner with associated signal drop thresholds without deviating from the scope of the invention. Also, in some cases, HI bands may not be available in a certain area or may be congested. In such cases, LO bands may be used exclusively (e.g., LO, two band LOLO CA, three band LOLO CA, etc.)

Herein, a single piece of user equipment, such as a smartphone or cellular modem, can be referred to as a “UE.” Multiple pieces of UE are referred to as UEs.

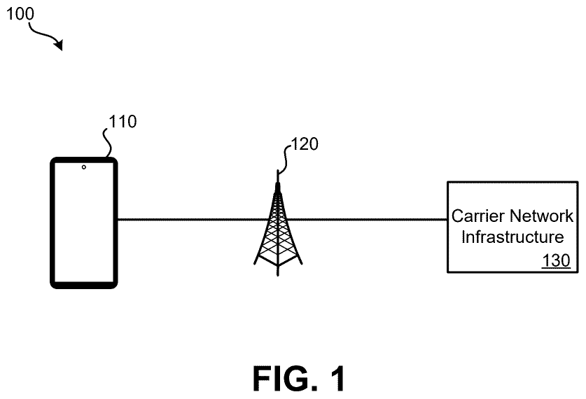

FIG. 1 is an architectural diagram of an embodiment of a system 100 of a carrier network that includes radio access network (RAN) 120 and carrier network infrastructure 130 and UE 110 configured to implement intelligent band switching, according to an embodiment of the present invention. UE 110 can be any form of computerized device that uses cellular communications, such as a smartphone, a gaming device, a tablet computer, a laptop computer, an IoT device, a cellular-enable sensor device, a cellular modem, an access point, etc. UE 110 communicates with carrier network infrastructure 130 via a RAN 120. RAN 120, which can be based on 5G New Radio, can include radio units (RUs), distributed units (DUs), and central units (CUs), which collectively form gNodeB (gNBs). While a single RAN is shown here, multiple RANs may be used, as discussed later herein. Carrier network infrastructure 130 may include computing systems and other equipment associated with breakout edge data centers (BEDCs), regional data centers (RDCs), national data centers (NDCs), etc.

Carrier network infrastructure 130 may provide various network functions (NFs) and other services. Carrier network infrastructure 130 can include a 5G New Radio (NR) cellular core. For instance, BEDCs may break out User Plane Function (UPF) data traffic (UPF-d) and provide cloud computing resources and cached content to UE 110, such as providing NF application services for gaming, enterprise applications, etc. RDCs may provide core network functions, such as UPF for voice traffic (UPF-v) and Short Message Service Function (SMSF) functionality. NDCs may provide a Unified Data Repository (UDR) and user verification services, for example. Other network services that may be provided may include, but are not limited to, Internet Protocol (IP) multimedia subsystem (IMS) IMS+telephone answering service (TAS) functionality, IP-SM gateway (IP-SM-GW) functionality (the network functionality that provides the messaging service in the IMS network), enhanced serving mobile location center (E-SMLC) functionality, policy and charging rules function (PCRF) functionality, mobility management entity (MME) functionality, signaling gateway (SGW) control plane (SGW-C) and user data plane (SGW-U) ingress and egress point functionality, packet data network gateway (PGW) control plane (PGW-C) and user data plane (PGW-U) ingress and egress point functionality, home subscriber server (HSS) functionality, UPF+PGW-U functionality, access and mobility management (AMF) functionality, HSS+unified data management (UDM) functionality, session management function (SMF)+PGW-C functionality, short message service center (SMSC) functionality, and/or policy control function (PCF) functionality. It should be noted that additional and/or different network functionality may be provided without deviating from the present invention. The various functions in this carrier system may be performed using dockerized clusters in some embodiments.

RAN 120 transmits wireless cellular signals in bands supported by the carrier. See Table 1 above, for example. UE 110 communicates with RAN 120 using one or more bands that have been assigned by carrier network infrastructure 130 (e.g., LO, LOLO, LOHI, etc.). The configuration is performed by carrier network infrastructure 130 and the actual assignment of the band(s) is performed in real time or near-real time by RAN 120. UE 110 also measures the received signal strength from RAN 120 in the assigned band(s), and potentially other band(s) that are not currently being used. For example, the UE may use signal strength, signal-to-noise ratio (SNR), and/or signal to interference and noise ratio (SINR). The received signal measurements may be a standard procedure for the UE based on the accuracy requirements stated in the 3rd Generation Partnership Project (3GPP) standards.

If UE 110 is using LO or LOHI, but the received signal strength from RAN 120 rises above a minimum acceptable signal strength threshold, UE 110 can request a switch to LOLO or to aggregate additional LO band(s) from RAN 120. In some embodiments, the request includes the hardware capabilities of UE 110 and/or the bands that UE 110 can use with its hardware. RAN 120 determines whether additional LO band(s) are reasonably available for use by UE 110. This determination may be made on the basis of congestion, interference, bands supported by UE 110, and the like. Ideally, all available frequencies would be aggregated for optimal use of the spectrum assets, providing a better service. However, the number of bands that can be aggregated via CA depends on the signal strength, the UE form factor, network congestion at the RAN on the bands, etc.

If additional LO band(s) are available under these criteria, RAN 120 assigns these band(s) to UE 110 and sends instructions to UE 110 to aggregate these band(s) for LOLO. UE 110 then switches its bands using band switching hardware and UE 110 communicates via the aggregated LOLO bands. Per the above, in some embodiments, three, four, or more LO bands may be assigned to and aggregated by UE 110 if the drop in signal strength is tolerable.

Various advantages may be provided by some embodiments. For instance, more of the available spectrum may be used when the signal strength permits. Also, higher data rates may be achieved. Furthermore, LOLO/LOHI switching is a more advantageous mechanism for performing load balancing than frequency handover. If LOLO is not permitted, frequency handover can be exercised for load balancing.

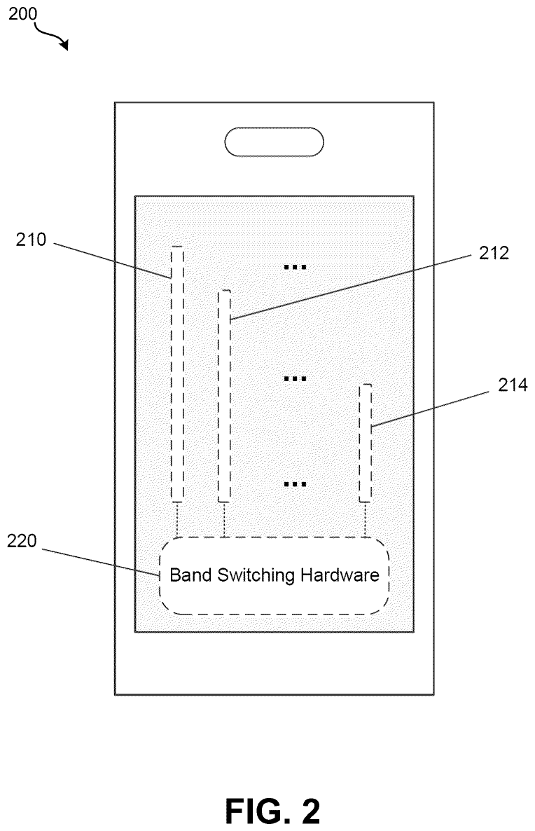

FIG. 2 illustrates a UE 200, such as a smartphone, with multiple antennas 210, 212, 214, according to an embodiment of the invention. UE 200 is capable of using multiple bands via its multiple antennas 210, 212, and 214. Modern smart phones frequently include four to thirteen different antennas. At least two are often used for the lower and upper cellular frequencies, and the antennas are usually spaced as far apart from one another as the form factor allows.

The optimum size for antennas can be half of the respective wavelength. However, the wavelengths of radio signals at frequencies used by smart phones can be relatively large. For instance, the wavelength of a radio signal with a frequency of 1 GHz is approximately one foot, and the wavelength at 2 GHz is approximately half a foot given that the wavelength is inversely proportional to the frequency. Thus, reducing the antenna size from the optimal size is usually desirable to provide a more compact form factor.

An antenna with a physical length of ¼ of the wavelength typically works well. Other techniques for reducing the antenna size may also be used, such as using the ground plane of the circuit board, using the UE cover, and/or zig-zagging the antenna trace on the board. While antennas smaller than an effective physical length of one-quarter wavelength may still work, the signal strength drops roughly with the area of the antenna, and the available frequency bandwidth shrinks.

In FIG. 2, antennas 210, 212, 214 are not necessarily to scale or the shape that would be implemented in a modern smart phone, but each is designed to perform well for a given supported wavelength. In this embodiment, antennas 210, 212 are designed for respective LO bands, and antenna 214 is designed for a respective HI band. Other antennas for other bands may be included without deviating from the scope of the invention. When operating in LOLO, antennas 210, 212 are used, potentially in conjunction with antenna 214. When operating in LOHI, antennas 210, 214, or 212, 214 are used. Band switching hardware 220 controls switching between using antennas 210, 212, 214, etc.

Antennas 210, 212, 214 are designed for particular frequencies, per the above. Band switching hardware 220 in this embodiment includes tunable switches or variable tuning capability for creating multiple resonances. For instance, an LC (inductance/capacitance) matching component may be used as part of band switching hardware 220 for the antennas. Multiple matching components are used to support multiple frequency transmission. The switching connects the desired antenna to the desired matching component. Antennas 210, 212, 214 should be connected to multiple matching components to prevent the matching components from creating multiple resonances. The switching may be mechanical, following the instructions from the UE processor(s). Software executed by the processor(s) may maximize the utilization of aggregated LO bands.

As previously noted, hardware (e.g., antenna, transceiver) of UE 200 can be unoptimized for having multiple LO frequency bands simultaneously active for wireless communication (i.e. LOLO). If LOLO is used, a significant loss of signal strength occurring due to the hardware of the UE when the multiple LO frequency bands are used for communication.

For example, switching from using n77 to n71 may result in a significant signal strength drop attributed to the hardware of UE 200 not being optimized for communication on the n71 band in combination with another LO frequency band that is currently active. Therefore, when LOLO is active, at least a 3 dB drop in signal strength attributed to the hardware of the UE not being optimized for use of multiple LO frequency bands can occur.

Despite the drop in signal strength, if sufficient signal strength remains present to communicate with a base station, the LOLO frequency bands can be used as part of a CA for uplink, downlink, or both communications between the UE and a cellular base station, such as using 5G NR radio access technology (RAT), using the same or a different modulation scheme.

In some embodiments, UE 200 is configured to only reveal its ability to use a LOLO frequency band arrangement if sufficient signal strength is detected on one or more other frequency bands (e.g., when a single LO frequency band is in use). For example, if n71 is currently being used for communication, if the received signal strength, such as received signal strength indicator (RSSI), is above a defined threshold value for a defined period of time, the UE can reveal to the cellular network, such as via a device capabilities message, that communication on a LOLO frequency band arrangement is available. By the UE revealing the ability to use a LOLO frequency band arrangement, the UE has already determined that even with an expected amount of signal loss, sufficient signal strength will be present for the UE to communicate with the BS of the cellular network using the LOLO frequency band arrangement.

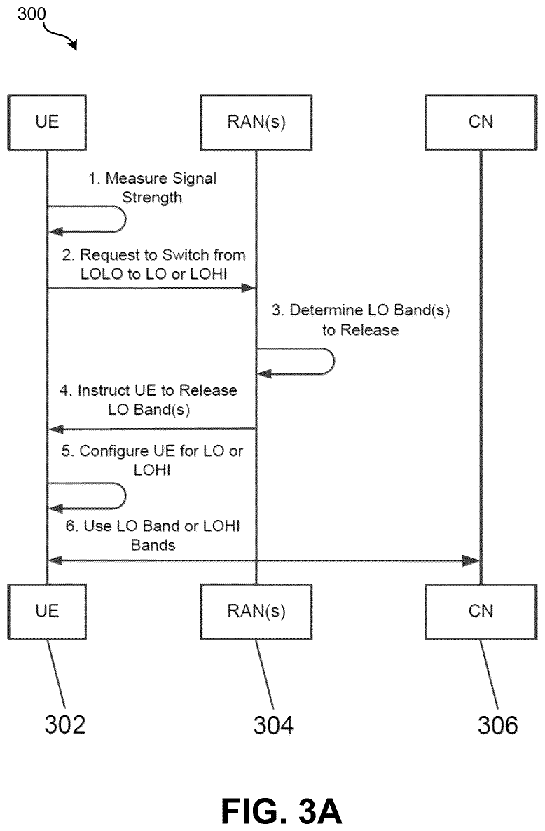

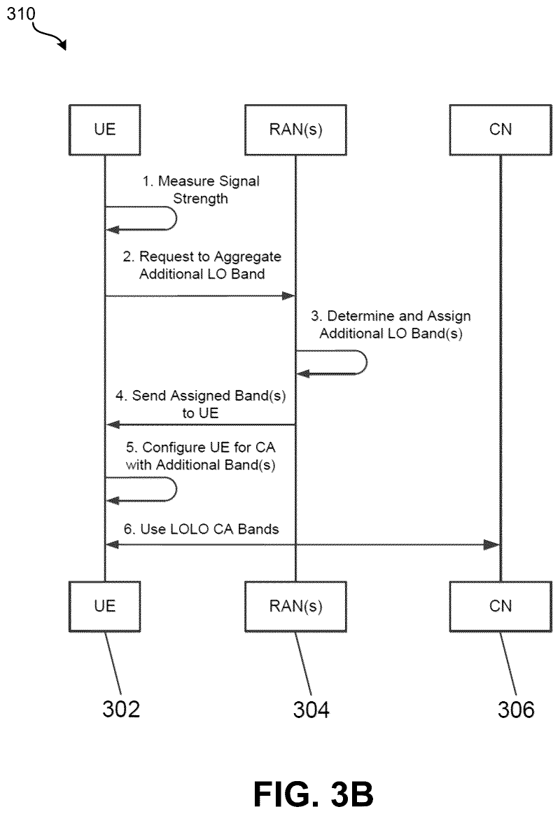

FIG. 3A is a flow diagram illustrating a process 300 for releasing at least one LO band, according to an embodiment of the present invention. UE 302, which is operating in LOLO in this embodiment, measures its received signal strength from RAN(s) 304. In other words, more than one RAN may be in range, and one or more bands may be used for communication therewith, potentially with a different set of bands per RAN. The received signal strength then drops below a minimum signal strength threshold. UE 302 then requests a switch from LOLO to LO or LOHI from carrier network 306, depending on whether HI band(s) are available in the area. In some embodiments, UE 302 may request the switch to LO or LOHI at the first instance of detecting the drop below the minimum signal strength, SNR, and/or SINR threshold, after multiple detected instances thereof during a detection period (e.g., one second, ten seconds, one minute, etc.), after a predetermined amount of time below the threshold, etc.

RAN(s) 304 determine LO band(s) for UE 302 to release and instructs UE 302 to release these LO band(s). UE 302 then configures itself to use the LO band or LOHI bands (e.g., by stopping use of one or more of the LO band(s)/antenna(s)) and uses the LO band or LOHI bands for communications. In some embodiments, multiple HI bands may be used in LOHI without deviating from the scope of the invention. In certain embodiments, one or more HI bands may not be available since HI band coverage is smaller than that of LO band coverage. In such a scenario, if the link cannot be maintained for LOLO, UE 302 and RAN(s) 304 may switch to using a single LO band.

FIG. 3B is a flow diagram illustrating a process 310 for aggregating at least one additional LO band, according to an embodiment of the present invention. UE 302, which is operating in LO, LOLO, or LOHI in this embodiment, measures its received signal strength from RAN 304. The received signal strength then rises above a minimum signal strength threshold for aggregation of one or more additional LO band. UE 302 then sends a request to RAN(s) 304 to aggregate additional LO band(s). In some embodiments, UE 302 may request the additional LO band(s) at the first instance of detecting the signal strength, SNR, and/or SINR being above a minimum threshold, after multiple detected instances thereof during a detection period (e.g., one second, ten seconds, one minute, etc.), after a predetermined amount of time above the minimum threshold, etc.

RAN(s) 304 determines one or more additional LO bands for UE 302 to aggregate, assigns UE 302 to these LO band(s), and sends the assigned LO band(s) for aggregation to UE 302. UE 302 then configures itself to aggregate these bands (e.g., by using respective additional band antenna(s)) and uses the LOLO bands for communications. In some embodiments, the HI band(s) may be released. If the signal strength drop can be tolerated and UE 302 supports them, any suitable number of LO bands may be aggregated without deviating from the scope of the invention.

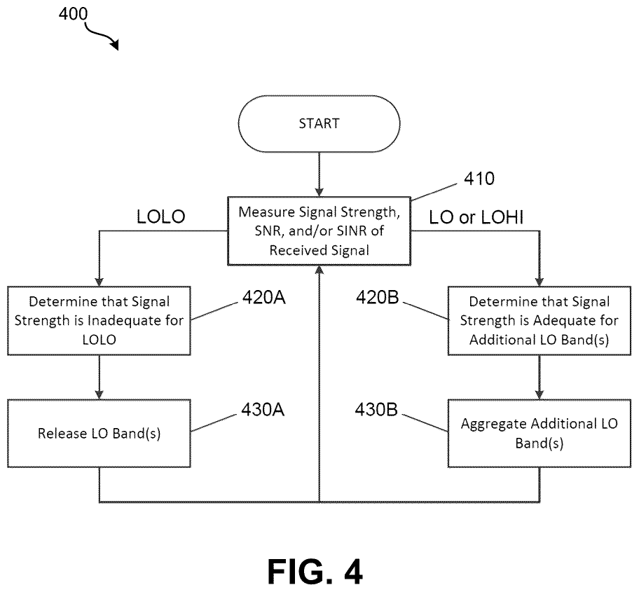

FIG. 4 is a flowchart illustrating a process for performing intelligent band switching, according to an embodiment of the present invention. The process begins with measuring a signal strength, SNR, and/or SINR of a signal received by UE at 410. When the UE is operating in LOLO mode, the UE determines that the received signal strength is inadequate for aggregation of the current LOLO CA bands by comparing the measured signal strength, SNR, and/or SINR to a minimum threshold at 420A. The UE then releases one or more LO bands of the current LOLO CA bands at 430A.

Measuring the SNR or SINR may be useful in certain scenarios as a primary parameter for LO band switching. For instance, in a sector-to-sector handover scenario where the UE is near the boundary between the sectors, the signal strength can be very high, but the SINR can be very low (e.g., below 0 dB). In such a case, the SINR may be used as the primary parameter for switching. In a site-to-site handover scenario, the UE may be in a noise-limited situation. In this case, the SNR may be the best parameter for determining whether to switch.

In some embodiments, the determination that the received signal strength is adequate for operation in the LOLO mode and/or aggregation of at least one additional LO band includes determining that the measured signal strength rose above the signal strength, SNR, and/or SINR were above the minimum threshold multiple times during a detection period, determining that the measured signal strength, SNR, and/or SINR were above the minimum threshold for at least a predetermined amount of time, or both. In certain embodiments, the threshold is a minimum threshold that enables the UE to maintain a link with RAN(s) and not be forced into handover. In some embodiments, the LOLO mode is used by the UE as a default when the received signal strength is adequate for the LOLO CA. In certain embodiments, the switching to the LO or LOHI mode includes sending a communication from the UE to RAN(s) requesting release of at least one LO band and receiving a communication from the RAN(s) including one or more LO bands to release. In some embodiments, the communication from the UE includes information pertaining to capabilities of the UE.

When operating in LO or LOHI mode, the UE determines that the received signal strength, SNR, and/or SINR are adequate for aggregation of at least one additional LO band by comparing the measured signal strength, SNR, and/or SINR to the minimum signal strength threshold at 420B. The UE then switches to a LOLO mode by aggregating at least one additional LO band with the current LO band(s) at 430B. Following step 430A and step 430B, the process returns to measuring the received signal strength at 410.

In some embodiments, the UE releases at least one HI band when aggregating LO bands for LOLO CA by switching the UE from using antenna(s) for the at least one HI band, using respective antennas for the at least one additional LO band to aggregate. In certain embodiments, the determination that the received signal strength, SNR, and/or SINR is inadequate for operation in LOLO mode includes determining that the measured signal strength, SNR, and/or SINR fell below the minimum threshold multiple times during a detection period, and/or determining that the measured signal strength, SNR, and/or SINR was below the minimum threshold for at least a predetermined amount of time. In some embodiments, the switching to the aggregating of the additional LO band(s) mode includes sending a communication from the UE to the RAN(s) indicating that the switch from the LOLO mode to the LO or LOHI mode should occur and receiving a communication from the carrier network including which LO band(s) to release.

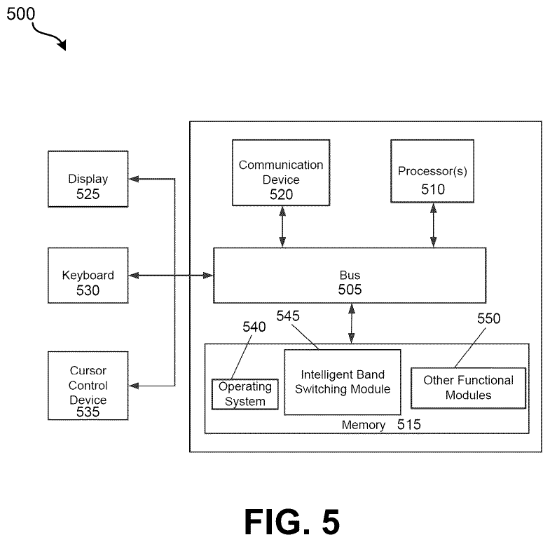

FIG. 5 is an architectural diagram illustrating a computing system 500 configured to perform intelligent band switching and/or aspects thereof, according to an embodiment of the present invention. In some embodiments, computing system 500 may be one or more of the computing systems depicted and/or described herein, such as UE, a carrier network computing system, a RAN computing system, etc. Computing system 500 includes a bus 505 or other communication mechanism for communicating information, and processor(s) 510 coupled to bus 505 for processing information. Processor(s) 510 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 510 may also have multiple processing cores, and at least some of the cores may be configured to perform specific functions. Multi-parallel processing may be used in some embodiments. In certain embodiments, at least one of processor(s) 510 may be a neuromorphic circuit that includes processing elements that mimic biological neurons. In some embodiments, neuromorphic circuits may not require the typical components of a Von Neumann computing architecture.

Computing system 500 further includes a memory 515 for storing information and instructions to be executed by processor(s) 510. Memory 515 can be comprised of any combination of random-access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 510 and may include volatile media, non-volatile media, or both. The media may also be removable, non-removable, or both.

Additionally, computing system 500 includes a communication device 520, such as a transceiver, to provide access to a communications network via a wireless and/or wired connection. In some embodiments, communication device 520 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 520 may include one or more antennas that are singular, arrayed, phased, switched, beamforming, beam steering, a combination thereof, and or any other antenna configuration without deviating from the scope of the invention.

Processor(s) 510 are further coupled via bus 505 to a display 525, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 525 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 530 and a cursor control device 535, such as a computer mouse, a touchpad, etc., are further coupled to bus 505 to enable a user to interface with computing system 500. However, in certain embodiments, a physical keyboard and mouse may not be present, and the user may interact with the device solely through display 525 and/or a touchpad (not shown). Any type and combination of input devices may be used as a matter of design choice. In certain embodiments, no physical input device and/or display is present. For instance, the user may interact with computing system 500 remotely via another computing system in communication therewith, or computing system 500 may operate autonomously.

Memory 515 stores software modules that provide functionality when executed by processor(s) 510. The modules include an operating system 540 for computing system 500. The modules further include an intelligent band switching module 545 that is configured to perform all or part of the processes described herein or derivatives thereof. Computing system 500 may include one or more additional functional modules 550 that include additional functionality.

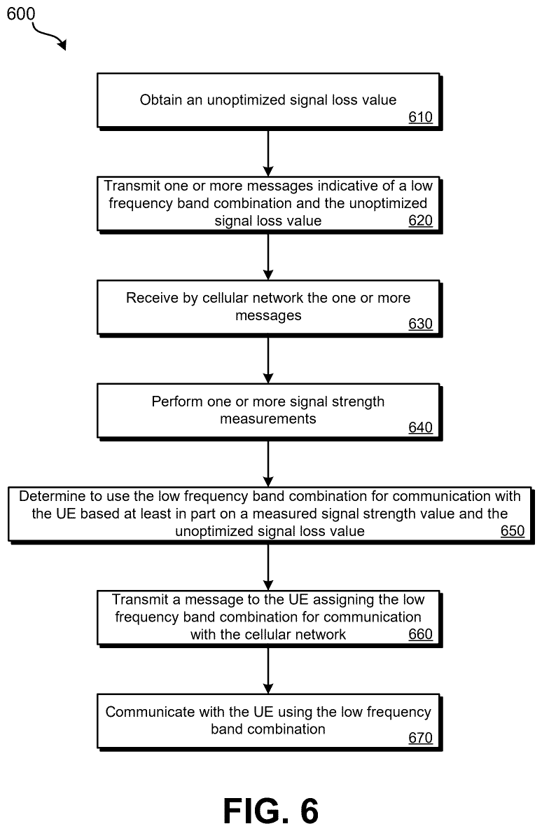

Method 600 of FIG. 6. is focused on how a system that includes a UE and cellular network can negotiate to use a frequency band for communication for which the hardware of the UE is not optimized and, thus, will result in a signal strength decrease due to the hardware of the UE, if the frequency band is used for communication. For example, a decrease in uplink, downlink, or both signal strengths may be on the order of 2 dB, 3 dB, or more as compared with other frequency bands which the UE is configured to use for communication with the cellular network.

Method 600 can begin with block 610, in which an unoptimized signal loss value is obtained. The unoptimized signal loss value is indicative of the amount of signal loss to be realized by using a particular set of low frequency bands together (i.e., a LOLO communication mode). This unoptimized signal loss value corresponds to either a group of LO frequency bands being used as (or as part of) a carrier aggregation for which the hardware of the UE is not optimized for using, such as the radios, transceivers, and antenna of the UE. The unoptimized signal loss value may be predefined (e.g., defined by a manufactured or operator of the cellular network) and stored by the UE. Alternatively, the UE may take measurements comparing the measured signal strength (e.g., reference signal received power (RSRP), signal-to-interference-plus-noise (SINR), RSSI) of signals received on while in the LOLO mode using the multiple LO frequency bands and comparing with another frequency band (e.g., single LO frequency band or HI frequency band) used by the UE for communication with the cellular network to calculate a value to use as the unoptimized signal loss value. In some embodiments, the cellular network may provide the UE with a defined value to use as the unoptimized signal loss value. In some embodiments, the value is measured in dB. For example, the unoptimized signal loss value may be 2 dB, 3 dB or some other value.

At block 620, one or more messages indicative of the combination of LO frequency bands and the unoptimized signal loss value can be transmitted to the cellular network. These messages may be sent by the UE to a base station of the cellular network with which the UE is presently communicating. In block 630, the cellular network may receive the one or more messages, which may include a device capabilities message. The one or more messages may be analyzed by a component of the gNodeB (gNB) of the cellular network. Specifically, the central unit (CU) of the gNB may analyze and process the received message. In some embodiments, the distributed unit (DU) of the gNB may analyze the one or more messages. As part of block 630, the unoptimized signal loss value along with an indication of the group of LO frequency bands with which it is associated may be stored by the cellular network in association with an indication of the UE. This record may be maintained for only the base station with which the UE is presently communicating or may be maintained as the UE moves among base stations (e.g., different gNBs). In some embodiments, multiple unoptimized signal loss values are provided for multiple sets of LO frequency bands that can be used together as part of a CA. That is, the amount of expected signal loss can vary based on the specific frequency ranges of different frequency bands.

At block 640, the cellular network may make one or more signal strength measurements of communication received from the UE, such as via a radio unit (RU) of the gNB. Additionally or alternatively, signal strength measurements may be made by the UE itself and the measurements or a calculation based on such measurements can be provided to the gNB of the cellular network. These measurements can serve as the basis for the cellular network to assess the viability of using the LOLO frequency bands for communication with the UE as part of the CA.

At block 650, based on the measured signal strength value and the unoptimized signal loss value, a component of the cellular network, such as the CU of the gNB, can determine whether to use the multiple LO frequency bands together for communication with the UE as part of the CA. This determination may involve an analysis of various parameters to make the decision. Specifically, the measured signal strength and the received unoptimized signal loss value can be used to calculate whether sufficient signal strength will be present if the LO frequency bands are used simultaneously for communication as part of the CA. The cellular network can calculate whether the measured signal strength, when the expected loss is taken into account due to the hardware limitations of the UE as reflected by the unoptimized signal loss value, will remain sufficient to maintain communications (possibly at a particular data transmission rate). The determination may take into account that the modulation used for communication between the UE and the cellular network will be altered, such as to a modulation that involves a lower data transmission rate.

In some embodiments, as part of block 650 or separately, a determination may be made to adjust the modulation scheme used for communication between the UE and base station. By adjusting the modulation scheme, the data transfer rate may be decreased, but the wireless communication channel may be less susceptible to signal loss. For example, the lower data transfer rate by using a different modulation scheme can allow for better error correction. As such, altering the modulation scheme can help compensate for the signal strength drop caused by using the multiple LO frequency bands.

At block 660, after the cellular network, such as the gNB, determines to use the LO frequency bands as part of the CA, a message can be transmitted to the UE. This message may assign the LO frequency bands for communication between the UE and the cellular network as part of the CA. The same or a separate message may also be used to communicate a change in modulation scheme. These frequency bands may be instead of or in addition to other carrier aggregations or frequency bands being used for communication, such as part of a LOLO configuration. Finally, at block 670, communication with the UE may occur (uplink, downlink, or both) using the multiple LO frequency bands. This communication may be in accordance with the 5G NR RAT or with some other cellular communication standard.

At block 670, communication using the CA that includes multiple LO bands may occur while the UE remains in communication with a particular base station. If inter-site handoff is required, such as due to the UE moving away from a first base station and toward a second base station, using multiple LO frequency bands may result in an increased likelihood of a dropped connection or call due to the lower signal strength. As such, if handover becomes necessary, first, the gNB or base station can coordinate transitioning the UE to communicating using a HI frequency band or a single LO frequency band. After transitioning, the inter-site handoff process may be performed. Once fully transferred, the new base station or gNB now in communication with the UE can determine whether to transition back to using multiple LO frequency bands should occur.

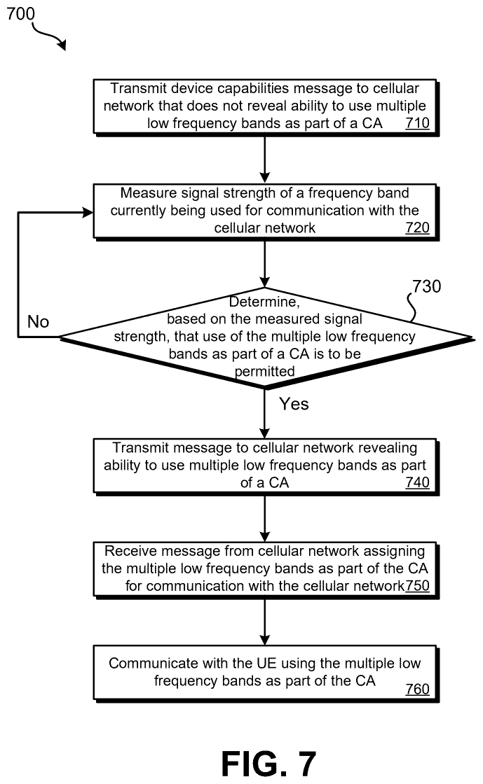

In method 600, the cellular network, or more specifically, the gNB of the cellular network receives an indication of an unoptimized signal loss value that takes into account the amount of expected signal loss due to the UE not being optimized to use multiple LO frequency bands as part of a CA. In contrast, method 700 of FIG. 7 is focused on making the determination whether to use multiple LO frequency bands as part of the CA at the UE instead of the RAN or core of the cellular network.

Method 700 can begin with block 710, in which a device capabilities message is transmitted to a cellular network. This initial device capabilities message may not reveal the ability of the device to use multiple LO frequency bands simultaneously as part of a CA for communication with base stations of the cellular network.

At block 720, the UE may measure the signal strength of a LO or HI frequency band currently being used for communication between the UE and a BS of the cellular network for downlink communications. The signal strength (e.g., RSRP, SINR, RSSI) may be measured over a period of time to determine an average value. The value may also be averaged for multiple frequency bands. At block 730, the UE may determine, based on the measured signal strength of the one or more frequency bands, that use of multiple LO frequency bands is to be permitted together as part of a CA. This determination can be based on specific criteria or thresholds related to the signal strength. For example, if the signal strength, as measured, allows for a sufficient margin to accommodate a defined amount of signal loss (e.g., equivalent to the unoptimized signal loss value of method 600) that multiple LO frequency bands can be used as part of a CA while still maintaining communication, the determination of block 730 can be made in the affirmative. Otherwise, method 700 may return to block 730 without the ability to use the multiple LO frequency bands together as part of a CA being revealed to the cellular network.

At block 740, in response to the affirmative result of block 730, a message may be transmitted to the cellular network, revealing the UE's ability to use the multiple LO frequency bands together in a CA. This message can be in the form of a device capabilities message. In method 700, no indication of an unoptimized signal loss value may be provided. Rather, the expected signal loss is factored in by the UE at block 730. This message can enable the cellular network (e.g., the gNB of the cellular network) to assign the multiple LO frequency bands for uplink and/or downlink communication with the UE.

At block 750, the cellular network may send a message to the device assigning the multiple LO frequency bands for communication in the CA. Finally, at block 760, communication between the BS or gNB of the cellular network and the UE may occur using the multiple LO frequency bands together in CA. If, at some time in the future, the signal strength decreases sufficiently, a future device capabilities message may be used to prevent the cellular network from assigning the multiple LO frequency bands for communication with the UE.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to emphasize their implementation independence more particularly. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 3A-4 may be performed by computer program(s), encoding instructions for the processor(s) to perform at least part of the process(es) described in FIGS. 3A-4, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 510 of computing system 500 of FIG. 5) to implement all or part of the process steps described in FIGS. 3A-4, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A system for cellular communication, the system comprising:
a user equipment (UE), wherein:
the UE is configured to communicate via a plurality of frequency bands with a cellular network; and
hardware of the UE is not optimized to communicate using multiple low frequency bands of the plurality of frequency bands together as part of a carrier aggregation (CA); and
the cellular network comprising a base station configured to communicate wirelessly via the plurality of frequency bands with the UE, wherein the cellular network is configured to:
receive, from the UE, one or more messages indicative of a pair of low frequency bands and an unoptimized signal loss value corresponding to use of the frequency band;
determine to use the pair of low frequency bands for communication with the UE based at least in part on a measured signal strength and the unoptimized signal loss value;
in response to determining, transmit a message to the UE assigning the pair of low frequency bands as part of the CA for communication with the base station; and
communicate with the UE using the pair of low frequency bands.

2. The system for cellular communication of claim 1, wherein the base station is further configured to transition to a lower order form of modulation in response to determining to use the pair of low frequency bands for communication.

3. The system for cellular communication of claim 1, wherein the hardware of the UE causes a signal strength loss of at least 2 dB when the pair of low frequency bands are used as part of the CA.

4. The system for cellular communication of claim 1, wherein each low frequency band is below 900 MHz.

5. The system for cellular communication of claim 1, wherein the unoptimized signal loss value is at least 3 dB.

6. The system for cellular communication of claim 1, wherein the one or more messages comprises a device capability message.

7. The system for cellular communication of claim 1, wherein a gNodeB of the cellular network is configured to determine to use the pair of low frequency bands for communication with the UE based at least in part on the measured signal strength and the unoptimized signal loss value.

8. A method for using multiple low frequency bands for cellular communication, the method comprising:
receiving, by a cellular network from a user equipment (UE), one or more messages indicative of a pair of frequency bands and an unoptimized signal loss value corresponding to use of the pair of low frequency bands as part of a carrier aggregation (CA), wherein:
the UE is configured to communicate via a plurality of frequency bands with a cellular network; and
hardware of the UE is not optimized to communicate using the pair of low frequency bands together as part of the CA;
determining, by the cellular network, to use the pair of low frequency bands for communication with the UE based at least in part on a measured signal strength and the unoptimized signal loss value;
in response to determining to use the pair of low frequency bands for the communication with the UE based at least in part on the measured signal strength, transmitting, by the cellular network, to the UE, a message that assigns the pair of low frequency bands for communication with a base station of the cellular network; and
communicating, by the cellular network, with the UE using the pair of low frequency bands.

9. The method for using the multiple low frequency bands for cellular communication of claim 8, wherein determining to use the pair of low frequency bands for communication with the UE based at least in part on the measured signal strength and the unoptimized signal loss value is performed by a central unit (CU).

10. The method for using the multiple low frequency bands for cellular communication of claim 8, further comprising: transitioning, by the cellular network, to a lower order form of modulation for communication with the UE in response to determining to use the pair of low frequency bands for communication.

11. The method for using the multiple low frequency bands for cellular communication of claim 8, wherein the hardware of the UE causes a signal strength loss of at least 2 dB when the pair of low frequency bands are used as part of the CA compared to another frequency band of the plurality of frequency bands.

12. The method for using the multiple low frequency bands for cellular communication of claim 8, wherein each of the low frequency bands is below 900 MHz.

13. The method for using the multiple low frequency bands for cellular communication of claim 8, wherein the unoptimized signal loss value is at least 3 dB.

14. The method for using the multiple low frequency bands for cellular communication of claim 8, wherein the one or more messages comprises a device capability message.

15. A non-transitory processor-readable medium for using an unoptimized frequency band for cellular communication, comprising processor-readable instructions configured to cause one or more processors to:
receive, from a user equipment (UE), one or more messages indicative of a pair of low frequency bands which the hardware of the UE is not optimized to use for communication as part of a carrier aggregation (CA) and an unoptimized signal loss value corresponding to use of the frequency band, wherein:
the UE is configured to communicate via a plurality of frequency bands with a cellular network; and
hardware of the UE is not optimized to communicate using the pair of frequency bands as part of the CA;
determine to use the pair of low frequency bands for communication with the UE based at least in part on a measured signal strength and the unoptimized signal loss value;
in response to determining to use the pair of frequency bands for the communication with the UE as part of a CA based at least in part on the measured signal strength, cause the cellular network to transmit to the UE, a message that assigns the pair of low frequency bands for communication with a base station of the cellular network; and
cause the cellular network to communicate with the UE using the pair of low frequency bands.

16. The non-transitory processor-readable medium of claim 15, wherein the processor-readable instructions configured to cause one or more processors to determine to use the pair of low frequency bands for communication with the UE based at least in part on the measured signal strength and the unoptimized signal loss value are executed at a central unit (CU) of the cellular network.

17. The non-transitory processor-readable medium of claim 15, wherein the processor-readable instructions are further configured to cause the cellular network to transition to a lower order form of modulation for communication with the UE in response to determining to use the pair of low frequency bands for communication as part of the CA.

18. The non-transitory processor-readable medium of claim 15, wherein the one or more messages comprises a device capability message.

19. The non-transitory processor-readable medium of claim 15, wherein the hardware of the UE causes a signal strength loss of at least 2 dB when the pair of low frequency bands are used as part of the CA compared to another frequency band of the plurality of frequency bands.

20. The non-transitory processor-readable medium of claim 15, wherein each of the low frequency bands is below 900 MHz and the unoptimized signal loss value is at least 3 dB.
